(19) United States
(12) Patent Application Publication
(10) Pub. No.: US 2011/0119050 A1
(43) Pub. Date: May 19, 2011

(54) Method for the automatic determination of context-dependent hidden word distributions

(76) Inventors: Koen Deschacht, Leuven (BE); Marie-Francine Moens, Herent (BE)

(21) Appl. No.: 12/927,651

(22) Filed: Nov. 18, 2010

Related U.S. Application Data
(60) Provisional application No. 61/281,461, filed on Nov. 18, 2009.

(51) Int. Cl. G06F 17/27

(52) U.S. Cl. 704/9

(57) ABSTRACT

Described is method, the Latent Words Language Model (LWLM), that automatically determines context-dependent word distributions (called hidden or latent words) for each word of a text. The probabilistic word distributions reflect the probability that another word of the vocabulary of a language would occur at that position in the text. Furthermore, a method is described to use these word distributions in statistical language processing applications, such as information extraction applications (for example, semantic role labeling, named entity recognition), automatic machine translation, textual entailment, paraphrasing, information retrieval, and speech recognition.

### CROSS-REFERENCE TO RELATED APPLICATION

This application claims the benefit of U.S. Provisional Patent Application Ser. No. 61/281,461, filed Nov. 18, 2009, the contents of the entirety of which are incorporated herein by this reference.

### TECHNICAL FIELD

Described herein are methods for the automatic analysis of natural language. More specifically, describe are methods that offer an intermediate representation of natural language that can be employed by other natural language processing methods resulting in an improved performance of these methods and/or reducing the need of these methods of a large manually annotated training corpus.

### BACKGROUND

Automatically learning sets of synonyms has received a considerate amount of attention from the research community, where we can generally distinguish two research directions.

The first class of methods tries to learn hard clusters of words, where all words in one cluster are considered to have the same meaning. Examples are clustering methods for language models (see, [4] for an overview), word sense disambiguation (see [12] for an overview) and text categorization (e.g., [13] and [14]). The assumption that words (or meanings) can be assigned to a single cluster possibly results in a representation that is not very precise, since all words in a cluster are assumed to have exactly the same meaning, which seldom holds in practice. The Latent Words Language Model (LWLM) method of the invention does not make a clustering assumption and does not assume that words have exactly the same meaning, only that words potentially share some meaning. This results in a representation that is more precise, allowing for more accurate natural language processing methods. We will see in the “Using the LWLM in NLP applications” section of this description that for one non-trivial information extraction task, semantic role labeling, our method achieves an error reduction of 30.53% compared to methods of the state of the art that employ word clusters as features.

A second class of methods tries to learn a measure of semantic similarity between words given the contexts of the words in a large text corpus. Examples of this type of research are [15], [16] and [17]. Similar to these methods, the LWLM method computes a measure of semantic similarity. A fundamental difference, however, is the fact that the LWLM is formulated as a probabilistic method. This results in two major advantages. First, the resulting semantic similarity is a probabilistic distribution, which is well founded and can easily be used as the input to other natural language processing (NLP) systems. Second, the probabilistic approach allows for an iterative re-estimate of the semantic similarities for the particular context a word is used in, which results in more accurate context models and thus more accurate semantic similarities compared to the methods of the state of the art.

A second important task performed by the LWLM method is, given the distributions of hidden or latent words, selecting the words that have the highest probability to be exchanged for a particular word in a particular context. This task is similar to automatic word sense disambiguation (WSD), which is the task of determining the sense or meaning of a word in a particular context. Take, for example, the word “ball.” According to the WordNet lexical database [18], this noun has twelve different meanings, among which are “round object that is hit or thrown or kicked in games,” “an object with a spherical shape” and “a lavish dance requiring formal attire.” Automatically determining the exact meaning of a word in a particular text is a non-trivial task and has attracted substantial attention from the research community.

The Semeval-2007 workshop organized a competition of WSD systems, comparing the performance of different systems on the same dataset. The system described in [19] was among the top performing systems and is a good example of a typical WSD system. It employs a supervised Maximum Entropy classifier that was trained on a manual-labeled training set. The classifier employs a large set of features that model the context, including the words, lemmas, collocations and Part-of-Speech tags (i.e., grammatical category of a word) in a small window (of size 3) before and after the word, named entities, selected keywords and bigrams in a large window and a small collection of other features. A search for the best features showed that the words and lemmas within a close window were most important to determine the meaning of the word.

The LWLM model probabilistically models these features in a straightforward way, as the sequence of hidden words left and right of the current word. Compared to the methods of the state of the art, this has the major advantage that the features are learned in a completely unsupervised way and can be used in a multitude of natural language processing (NLP) applications. Furthermore, the hidden words provide a representation that capture similarities between words, thus reducing the need for other features such as Part-of-Speech tags.

### DISCLOSURE

Provided are methods for determining a probabilistic, context-dependent word distribution (206) for each word in a previously unseen text. Methods for determining a probabilistic, context-dependent word distribution (206) for each word in a previously unseen text comprises the steps of:
(a) in a training phase, learning for each word of a large corpus of natural language texts a probabilistic context model (104a) that describes the context these words typically occur in and learning a hidden-to-observed distribution (104b) that describes words with similar meaning and usage;
(b) storing the context model (104a) and the hidden-to-observed distribution (104b) on a storage device; and
(c) in an inference phase, retrieving the context model (104a) and the hidden-to-observed distribution (104b) from the storage device and for each word in the previously unseen text determining the probabilistic, context-dependent word distribution (206) using the context model (104a) and the hidden-to-observed distribution (104b) obtained in the training phase.

In certain embodiments, the training phase of the probabilistic context model (104a) and the context-dependent word distribution (104b) are iteratively refined.

In another embodiment, the training phase comprises the steps of
(a) tokenizing the corpus of natural language texts into individual words;
(b) representing the corpus of natural language text with a Bayesian model with a hidden or latent variable for every word in the corpus, the Bayesian model representing the context-dependent set of similar words, and with dependencies between the hidden variable and the hidden variables in its context, the dependencies representing the context model, and with dependencies between the hidden variable and the observed word at that position, the dependencies representing the hidden-to-observed distribution; and
(c) using approximate inference methods to determine a probabilistic distribution of words for the hidden variables, to learn the context model (104a) and to learn the hidden-to-observed distribution (104b).

In yet another embodiment, the inference phase comprises the steps of:
(a) tokenizing the text into individual words;
(b) representing the text with a Bayesian model with a hidden or hidden variable for every word in the corpus, the Bayesian model representing the context-dependent set of similar words, and with dependencies between the hidden variable and the hidden variables in its context and between the hidden variable and the observed word at that position;
(c) using the context model (104a) and the hidden-to-observed distribution (104b) learned in the training phase together with approximate inference methods to determine a probabilistic distribution of words for the hidden variables in a previously unseen text (206); and
(d) the probabilistic, context-dependent word distribution for each word in a previously unseen text determined by the methods of the invention can be used in methods for automatic analysis of natural language, for example, semantic role labeling.

Herein is described the Latent Words Language Model (LWLM), a novel method for determining a probabilistic, context-dependent word distribution (called hidden or latent words) for each word of a text. The probabilistic word distribution reflects the probability that another word of the vocabulary of a language would occur at that position of a word in the text resolving problems of synonymy and word sense disambiguation. The vocabulary is composed of the distinct words found in the corpus under consideration. This method has two phases, the training phase and the inference phase.

In the first phase, called the training phase (see FIG. 1), of the LWLM method, we learn the probabilistic hidden word distribution (105 in FIG. 1) for each word of a training set. The method automatically learns these distributions from a set of natural language texts and does not require manual labeling or human intervention, although manual labelings can easily be incorporated.

A raw text corpus is first processed by a text tokenization system (100), which tokenizes the text into words.

From the tokenized text, an initial context model (101) is learned, which is then used to learn which words occur in similar contexts, and create an initial hidden-to-observed distribution (102).

Iteratively, the hidden-to-observed distribution and the context model are updated (103) in two steps. In the first step, the values for the hidden variables (105) are updated in the training corpus as follows: for every position in the training corpus, the words likely to occur at that position are determined, which is given by the context model, and the words that are similar to the observed word are determined, which is given by the hidden-to-observed model. The outputs of these models are then combined to estimate the value for the hidden variable at that position.

In a second step, the context model is updated by collecting all the counts from the hidden variables and their contexts in the training corpus and the hidden-to-observed model is updated by collecting all the counts from the hidden variables and the observed words in the training corpus.

This iteration is performed a number of times until the two models converge to a stationary value, after which they are stored on a storage device for later use.

In the second phase, called the inference phase, the LWLM infers a context-dependent probability distribution of the hidden word for every word in a previously unseen text and uses these distributions in a Natural Language Processing (NLP) application (see FIG. 3). This step allows inference of probability distributions for hidden words for texts that were not part of the large training set.

A previously unseen text is split into words by a text tokenization system (100). Equivalent to the training phase, the LWLM method introduces a hidden variable for every word in the text. The value of every hidden variable is initially set to the distributions of words that are similar to the observed word, as given by the hidden-to-observed model (which is read from the storage device 104b).

The context model (104a) is then read from the storage device and used to iteratively improve the estimates of the hidden words (205). After a number of iterations, the probability distributions of the hidden words converge to an equilibrium (206) and can be passed to an NLP application (204) that can use them as an intermediate representation of natural language, in which lexical ambiguity and synonymy are resolved in a context-sensitive way.

### BRIEF DESCRIPTION OF THE FIGURES

FIG. 1: Overview of the training phase of the LWLM method.

FIG. 2: Example of a Bayesian network used for the LWLM method. Grey circles are observed variables, white circles are hidden variables, and arrows represent directed dependencies.

FIG. 3: Overview of the inference phase of the LWLM method.

### DETAILED DESCRIPTION OF THE INVENTION

### Definitions

A “hidden word” is defined for a particular word at a certain position in a text as a probability distribution of words of the vocabulary of a language that share a similar meaning with that word at that position. The probability distribution indicates how likely a word of the vocabulary is to be identical to the given word in semantic meaning and usage in the text at that particular position.

A context model is defined as a probabilistic model of natural language text that models the distribution of words at a certain position in a text, given the context of that word at that position. In this work, we define the context as the hidden words in a certain window size left and right of this position in the text and we learn the context model from a large unlabeled training corpus.

The hidden-to-observed model is defined as a probabilistic model that models the distribution of observed words given a certain hidden variable in the text. This model essentially captures word similarities, assigning high probability to observed words for a particular hidden word that are similar in meaning and usage to this hidden word and low probabilities to words that are not similar.

A novel method, the Latent Words Language Model (LWLM), is described that automatically determines context-dependent word distributions (called hidden or latent words) for each word of a text. The probabilistic word distributions reflect the probability that another word of the vocabulary of a language would occur at that position in the text. Furthermore, a method is described to use these word distributions in statistical language processing applications, such as information extraction applications (e.g., semantic role labeling, named entity recognition), automatic machine translation, textual entailment, paraphrasing, information retrieval and speech recognition.

The Latent Words Language Model (LWLM) consists of two phases. In the first phase, called the training phase, the method learns the context-dependent word distributions for each word of a large corpus of texts, resulting in a probabilistic context model (104a) that describes the context these words typically occur in, and in a hidden-to-observed distribution (104b) that describes words that are similar in meaning and usage. In a second phase, called the inference phase (205), the context-dependent word distributions are inferred for each word of a text, which is not part of the training set, using the context model (104a) and hidden-to-observed distribution (104b) obtained in the previous phase.

In the training phase (first phase), we learn the probabilistic hidden word distribution for each word of the unlabeled training text.

### Text Tokenization

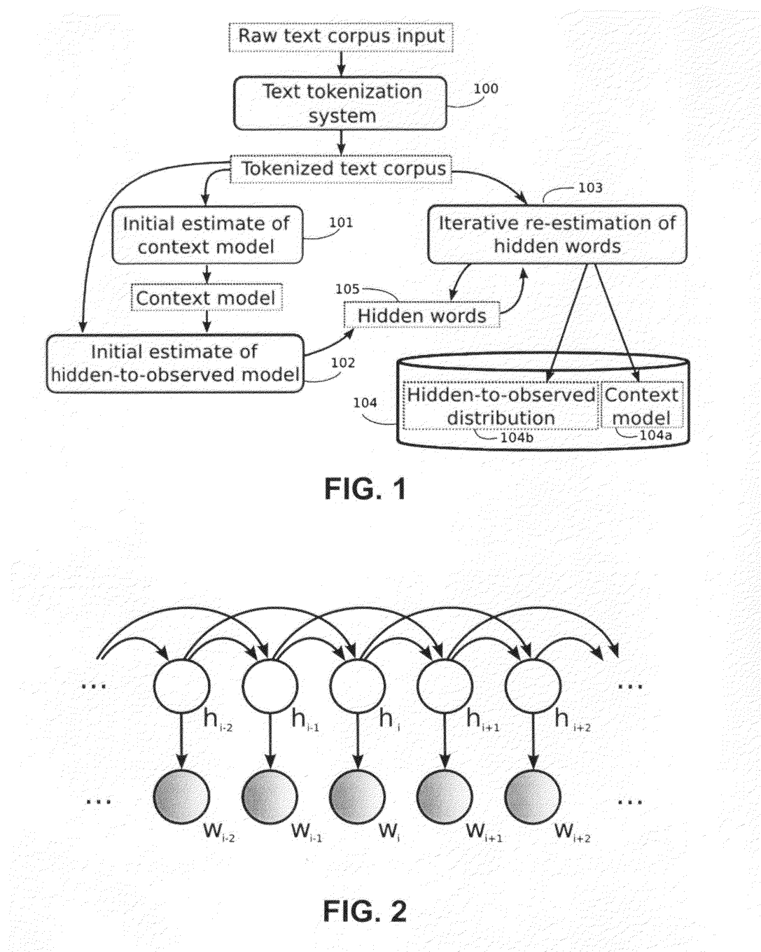

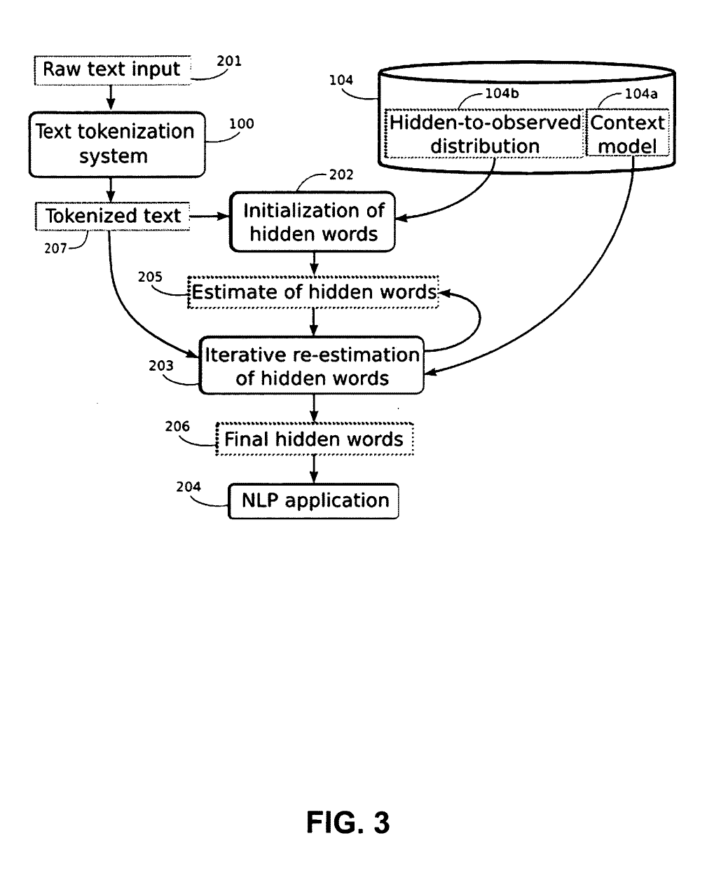

In a first step, the training corpus of text is tokenized into words (100 in FIG. 1). Different existing tokenization systems could be used (see, for example, [1]) and we will not describe such a system here.

Learning the Hidden Word Model from a Large Training Corpus

The conceptual framework that is used in the LWLM is a Bayesian network with hidden variables, more specifically, a network (see example in FIG. 2) with for every word at position i in the text, one observed variable wᵢ representing the word at that position in the text and one hidden variable hᵢ with unknown value. The hidden variable represents the hidden word probability distribution for the word at that position, i.e., the words that could replace the observed word at that position without drastically changing the meaning of the text and their probability of occurrence. The probability distribution is defined over all possible words of the vocabulary of the large training set, which is expected to contain most of the words of the vocabulary of a language.

The Bayesian network also models conditional dependencies between the different variables, more specifically between the observed variable wᵢ and the hidden variable hᵢ and between the hidden variable hᵢ and its context cᵢ. This defines two conditional distributions. The hidden-to-observed distribution, P(wᵢ|hᵢ), is the distribution of observed words given the hidden word, and the context model, P(hᵢ|cᵢ), is the distribution of hidden words given the context of the word. We model the context of the word using the sequence of n hidden words hᵢ₋ₙ . . . hᵢ₋₁ left of the current word and of n hidden words hᵢ₊₁ . . . hᵢ₊ₙ right of the current word, where n is a small constant and set P(hᵢ|cᵢ)=P(hᵢ|hᵢ₋ₙ . . . hᵢ₋₁,hᵢ₊₁ . . . hᵢ₊ₙ).

### Initial Estimate of the Context Model

The values of the hidden variables are not observed directly, and are iteratively estimated. The LWLM method starts by estimating the context model P(hᵢ|hᵢ₋ₙ . . . hᵢ₋₁,hᵢ₊₁ . . . hᵢ₊ₙ) (101) by collecting the counts of a particular word occurring in a particular context in the training corpus. Estimating this distribution accurately is hard because of the limited number of times this exact context will be observed in the training corpus. We estimate this distribution using, for instance, Kneser-Ney smoothing [2] that combines (specific, but possibly inaccurate) higher order n-gram models with (less specific, but probably more accurate) lower order n-gram models. So, in a first iteration, the values of the hidden variables h⁽¹⁾ are initialized (e.g., by setting the value of every hidden word hᵢ at position i as the distribution of observed words that are likely to occur at that position given the words occurring before or after that position as, e.g., as obtained through a standard n-gram model.

### Initial Estimate of the Hidden Word Distributions in the Training Set

The context model is used to estimate, for every word in the training text, the probabilistic set of words that could have appeared at that position, given the context for that word at that position and the context model (102). One word is randomly selected from this set of possible words and assigned to the hidden word at that position (105).

### Iterative Re-Estimate of the Hidden Word Distributions in the Training Set

After initialization, we perform approximate inference, for example, by using the Gibbs sampling method [3] (103) in order to obtain good estimates for the hidden word probability distributions. Gibbs sampling is a Markov Chain Monte Carlo sampling technique that iteratively generates a number of samples of the expected value of the hidden variables. After initialization (see above), in every iteration τ, the current sample h^{(τ)} is used to generate the next sample h^{(τ+1)}. Every position i is visited in turn and the distribution of the hidden variable hᵢ at that position is computed as:

$$p ( {h}_{i} \vert {h}_{- i} , w , {C}^{( τ )} , γ ) = \frac{\begin{matrix}P ( {w}_{i} \vert {h}_{i} , {C}^{( τ )} , γ ) P ( {h}_{i} \vert {h}_{i - n + 1}^{i - 1} , {C}^{( τ )} , γ ) \\ {\prod }_{j = i + 1}^{i + n - 1} P ( {h}_{j} \vert [ {h}_{j - n + 1}^{i - 1} {h}_{i} {h}_{i + 1}^{j - 1} ] {C}^{( τ )} , y )\end{matrix}}{\begin{matrix}{\sum }_{{h}_{i}^{*} ∈ V}^{ } P ( {w}_{i} \vert {h}_{i}^{*} , {C}^{( τ )} , γ ) P ( {h}_{i}^{*} \vert {h}_{i - n + 1}^{i - 1} , {C}^{( τ )} , γ ) \\ {\prod }_{j = i + 1}^{i + n - 1} P ( {h}_{j} \vert [ {h}_{j - n + 1}^{i - 1} {h}_{i}^{*} {h}_{i + 1}^{j - 1} ] {C}^{( τ )} , y )\end{matrix}}$$

where h₋ᵢ is the collection of values for all hidden variables except for hᵢ, hᵢ* ranges over all values of the vocabulary V, C^{(τ)} is the collection of counts derived from h₋₁ and w, P(hⱼ|[hᵢ₋ₙ₊₁ⁱ⁻¹hᵢhᵢ₊₁^{j-1}]C^{(τ)},γ) is the probability of hᵢ given the sequence of hidden variables hᵢ₋ₙ₊₁ⁱ⁻¹, and P(hⱼ|[hⱼ₋ₙ₊₁ⁱ⁻¹hᵢhᵢ₊₁^{j-1}]C^{(τ)},γ) is the probability of hⱼ given the sequence of hidden variables [hⱼ₋ₙ₊₁ⁱ⁻¹hᵢhᵢ₊₁^{j-1}], and where γ represents a smoothing parameter. Note that we use [hⱼ₋ₙ₊₁ⁱ⁻¹hᵢhᵢ₊₁^{j-1}] to denote the sequence of hidden words that is obtained by appending hⱼ₋ₙ₊₁ⁱ⁻¹, hᵢ and hᵢ₊₁^{j-1}, and that hⱼ₋ₙ₊₁ⁱ⁻¹=[hⱼ₋ₙ₊₁ . . . hᵢ₋₁].

The probability in the above equation is computed for all possible values of hᵢ. One value is selected according to this distribution and the hidden variable is set to this value. Gibbs sampling then continues by sampling a value for hᵢ₊₁, and so on, until a new value is sampled for all values in h. This process is repeated a number of iterations. During the burn-in period, the different distributions converge from the initial estimates to the true Maximum Likelihood estimate, which is the equilibrium point for the Gibbs sampling procedure. After the burn-in period, a number of iterations are performed in which Gibbs sampling oscillates around the Maximum Likelihood estimate. The samples are stored at specific intervals to be independent of each other. Finally, all samples are summed to compute the final distributions.

### Store Distributions on Storage Device

After the Gibbs sampling, we have computed accurate probabilistic distributions of each hidden word of the training set allowing to infer a final context model (104a) as described in step 3 and a hidden-to-observed model (104b) as described in step 2. These distributions are then stored on a storage device (104) for later use.

### Variations

The implementation of the LWLM method can be adapted in different ways. We will outline some of these variations in this section and motivate that none of these is critical to the nature of the described method.

We chose to represent the context of a particular word as the sequence of n words left and right of that word. Other methods to represent the context include:
a (weighted) bag of words that does not take order information into account: by discarding the sequential ordering information, the resulting probability distributions will be less specific, even when using a much larger set of texts for training, making it much harder to learn an accurate set of synonyms.
a representation using the head word(s) for every word as defined by a syntactic dependency tree of the sentence as constructed by a dependency parser. Although this method allows potentially for a more accurate representation of the context, it depends on a dependency parser, which is only available for a small number of languages and domains.

Given a certain representation of the context, different methods could be used to compute a probability distribution from the counts in the training corpus. Most notably are the Maximum Likelihood method and the smoothing methods traditionally used for language models such as Katz smoothing, Jelinek-Mercer smoothing and Kneser-Ney smoothing (see [4] for an overview of different smoothing techniques). It is well known that the Maximum Likelihood methods produce poor estimates of the probability distribution because of the high variation of natural language. For this reason, different smoothing methods have been proposed. In an extensive comparison, it was found that for language models, Kneser-Ney outperforms other smoothing methods [4].

We have used Gibbs sampling to estimate the values of the hidden variables. Other approximate inference methods could have been used, such as other methods based on the Markov Chain Monte Carlo sampling techniques and algorithms based on the Expectation-Maximization technique. It is known that Expectation-Maximization suffers from the local maxima problem, where the inference method reaches a non-optimal equilibrium point [5]. The Gibbs sampling method is easy to implement and has similar results compared to other Markov Chain Monte Carlo techniques, although some of these might be computationally more efficient.

### Inferring Context-Dependent Hidden Words Model for a New Text

In this section, described is the second phase, the method to determine the probability distributions of the hidden words of a new, previously unseen text. The conceptual framework that is used is again a Bayesian network with one hidden variable for every word of the text.

### Text Tokenization

First, the new text (201) is tokenized by the text tokenizer (100).

### Initialization of the Hidden Word Distributions of the New Text

The initialization module uses the tokenized text (207) and initializes the hidden variables for every observed word. The hidden-to-observed distribution (104b), which was computed in the previous section, is read from the storage device (104). The initial estimate of the distribution (202) of hidden words for every observed word is then set to the distribution of hidden words for this observed word given by the hidden-to-observed distribution.

### Iterative Estimate of the Hidden Words Distributions of the New Text

Estimating the values of the hidden variables is performed as in the previous section, with the exception that the probability distributions, P(hᵢ|hᵢ₋ₙ . . . hᵢ₋₁,hᵢ₊₁ . . . hᵢ₊ₙ) and P(wᵢ|hᵢ) are taken from the previous phase and are not modified during this phase. These distributions are stored as the context model (104a), which is read from the storage device (104).

The hidden variables are iteratively updated (203) using, for instance, the loopy belief propagation method. This method performs inference on the Bayesian network by passing messages between dependent variables, which are respectively the hidden word and observed word, and the hidden words and the hidden words in its context. After a small number of iterations, these estimated distributions for the hidden variables (205) converge to a stable value and are returned to a NLP application (204) that can use them as an intermediate representation of natural language.

### Variations

Other techniques could have been used to estimate the distributions for the hidden variables. Extensions of the loopy belief propagation method, such as Generalized Belief Propagation [6], might achieve slightly better results, but are significantly harder to implement. A different class of methods is based on Markov Chain Monte Carlo techniques (e.g., [7]). Although different in approach, we do not expect that these methods will significantly produce other results, since the context model (104a) or hidden-to-observed distribution (104b) are not adapted during inference and all methods are expected to converge to the same equilibrium point after a number of iterations, resulting in equivalent estimates for the hidden variables.

### Using the Hidden Words Distributions for Natural Language Processing

In this section, we outline how the results of the LWLM, i.e., the context-dependent hidden words distributions can be used for NLP applications. We will see how this approach results in improved performance and reduced need for a large training for two non-trivial NLP applications: a sequential language model and a Semantic Role Labeling system.

Although the structure of a natural language text (i.e., a sequence of characters or words) is intuitive for humans, NLP applications have to represent the text in a way that is better suited for an automatic analysis. Typically, the character stream is converted to a sequence of features. The exact features depend on the application, but typically include word tokens, word lemmas (or stems) and syntactic properties such as Part-of-Speech tags and the syntactic dependency tree of the sentence. The hidden words distributions can easily be incorporated in such a feature representation where, for instance, the probability distribution of alternative words at each position in the text can be concatenated to the existing feature vector.

The probabilistic context-dependent hidden words distributions contribute to an NLP application in two ways. (1) They capture the meaning of a particular word in a particular context. (2) Most statistical NLP systems use a training corpus that has been manually annotated to collect statistics of how patterns in natural language correlate with the task that needs to be solved. This approach suffers from the sparsity problem: language offers many different ways to express the same content and even a very large training corpus will not contain all patterns that might be encountered in a previously unseen text. The LWLM method offers a (partial) solution to this problem, since it determines a set of synonyms for every word, and thus offers a method to virtually expand the training set.

### Sequential Language Model

In a first application, we describe the use of the LWLM method in a sequential language model. Sequential language models provide a probability distribution over the (unknown) next word, given the current and previous words. They are used for speech recognition where they help to convert the ambiguous sound signal to written text.

The method proceeds as follows: one hidden variable is introduced for the current word and one for every previous word in the text. We then use loopy belief propagation to estimate the distributions of the hidden variables. The estimated distributions for the hidden variables are used in combination with the learned conditional distribution on the previous hidden variables to estimate a distribution on the next word. This estimate is interpolated with the estimate of a standard n-gram model to produce a probability distribution over the next word.

To measure the performance of a language model, one measures the likelihood L(Tₜₑₛₜ) of an unseen test text, given the model. The perplexity is then computed as

Perplexity=Y\sqrt{L(Tₜₑₛₜ)}

where Y is the length of the test text. Table 1 compares the result of the LWLM model with a state-of-the-art smoothing language model, interpolated Kneser-Ney (IKN) and a state-of-the-art cluster-based language model (Cluster), the fullibmpredict method of [4]. We have tested the language models using an n-gram length of 3 and 4 on three different corpora, a collection of news texts distributed by Reuters (Reuters-21578, http://daviddlewis.com/resources), the first 500 articles from the English Wikipedia (EnWiki) and a collection of news texts distributed by Associated Press (APNews).

We see how the LWLM model outperforms the other models on all corpora, for 3-grams, 4-grams and 5-grams. This shows that the learned synsets are of a high quality and provide a more precise representation than semantic clusters.

TABLE 1
Perplexity of the Interpolated Kneser-Ney, Cluster-
based and LWLM models on three different corpora.

| | Reuters | APNews | EnWiki |
|---|---|---|---|
| IKN 3-gram | 113.15 | 132.99 | 160.83 |
| Cluster 3-gram | 108.38 | 125.65 | 149.21 |
| LWLM 3-gram | 99.12 | 116.65 | 148.12 |
| IKN 4-gram | 102.08 | 117.78 | 143.20 |
| Cluster 4-gram | 102.91 | 112.15 | 142.09 |
| LWLM 4-gram | 93.65 | 103.62 | 134.68 |
| IKN 5-gram | 114.96 | 134.42 | 161.41 |
| Cluster 5-gram | 108.38 | 125.65 | 149.21 |
| LWLM 5-gram | 96.49 | 122.55 | 138.49 |

### Semantic Role Labeling

In a second application, we describe the use of the LWLM method for Semantic Role Labeling (SRL). SRL is the task of automatically assigning semantic roles to sentence constituents. A semantic role is a label that indicates the relationship of the sentence constituent with a verb. An example of an annotated sentence is:

[John Arg0] [broke BREAK.01] [the window Arg1] [into a million pieces Arg3].

In this sentence, “broke” is the verb with meaning BREAK.01 “cause to not be whole” which has semantic roles Arg0 “Agent,” Arg1 “Thing broken” and Arg3 “Patient.” In previous work, we have developed a Semantic Role Labeling system that was based on state-of-the-art systems such as described in the CoNLL-2004 shared task [8]. These systems rely heavily on a large annotated corpus, the PropBank corpus [9]. We expand the feature vector used in our SRL system (which already contains features such as the word token, the part-of-speech tag of the word and its position in the parse tree relative to the verb) with the probability distribution for the hidden variable for that word. This expanded feature vector is then used in a classifier that performs SRL.

Table 2 shows the results of our standard state-of-the-art SRL system (SRL), comparable to the system described in [10], and a SRL system that employs the distribution over the hidden words as additional features (LW SRL). We have also compared our method with a state-of-the-art SRL system that employs word clusters learned by the fullibmpredict method of [4] as additional features (Cluster SRL), allowing for a comparison with a system that employs a representation that contains information on similar words. All systems were trained on training sets of varying sizes (shown as % of the original training corpus of the CoNLL-2008 shared task [11]) and evaluated on the test set of the CoNLL-2008 shared task. We see that the LW SRL system outperforms the other systems for all sizes of the training set. Furthermore, we see that the standard SRL model performs significantly worse than the other methods for small sizes (5% and 20%) of the training set. This is most likely caused by the sparsity problem that is more severe for smaller training sets. We also see that for large sizes of the training set, the clustering method is significantly worse than the other two methods. This is caused by the clusters that were employed as extra features. These clusters merge many words into one cluster, which leads to good generalization but potentially hurts precision. The LW SRL performs well overall, indicating that the hidden words employ a precise representation of words that still allows for good generalization when using small training sets.

TABLE 2
Results in terms of F1-measure on the CoNLL-2008 test set of a state-
of-the-art semantic role labeling system (SRL), a system using semantic
clusters (Cluster SRL) and a system using co-synsets (LW SRL) as
additional features, trained on training sets consisting of 5%, 20%,
50% or 100% of the full CoNLL-2008 training corpus.

| | 5% | 20% | 50% | 100% |
|---|---|---|---|---|
| SRL | 40.49% | 67.23% | 74.93% | 78.65% |
| Cluster SRL | 59.51% | 66.70% | 70.15% | 72.62% |
| LW SRL | 67.15% | 78.84% | 80.76% | 83.53% |

### REFERENCES

[1] U.S. Pat. No. 5,806,021 Chengjun Julian Chen, Fu-Hua Liu and Michael Alan Picheny, Automatic Segmentation of Continues Text Using Statistical Approaches, 1998
[2] R. Kneser and H. Ney, Improved backing-off for m-gram language modeling. In Proceedings of the International Conference on In Acoustics, Speech, and Signal Processing, 1995
[3] S. Geman and D. Geman, Stochastic relaxation, Gibbs distributions and the Bayesian restoration of images, IEEE Transactions on Pattern Analysis and Machine Intelligence, 1984
[4] S. F. Chen and J. Goodman, An empirical study of smoothing techniques for language modeling, Computer Speech and Language, 1999
[5] N. Ueda and R. Nakano, Deterministic annealing EM algorithm, Neural Networks, 1998
[6] J. S. Yedidia, W. T. Freeman and Y. Weiss, Generalized belief propagation, Advances in neural information processing systems, 1998
[7] E. B. Sudderth, A. T. Ihler, W. T. Freeman, and A. S. Willsky, Nonparametric belief propagation. In Proceedings of the Conference on Computer Vision and Pattern Recognition, 2003
[8] X. Carreras and L. Marquez, Introduction to the CoNLL-2004 shared task: Semantic role labeling. In Proceedings of CoNLL-2004, 2004
[9] M. Palmer, D. Gildea and P. Kingsbury, The proposition bank: An annotated corpus of semantic roles, Computational Linguistics, 2005
[10] J. H. Lim, Y. S. Hwang, S. Y. Park and H. C. Rim, Semantic role labeling using maximum entropy model. In Proceedings of the CoNLL-2004 Shared Task, 2004
[11] M. Surdeanu, R. Johansson, A. Meyers, L. Marquez and J. Nivre, The CoNLL-2008 shared task on joint parsing of syntactic and semantic dependencies. In Proceedings of the 12th Conference on Computational Natural Language Learning, 2008
[12] E. Agirre and A. Soroa, Semeval-2007 task 02: Evaluating word sense induction and discrimination systems. In Proceedings of the 4th International Workshop on Semantic Evaluations, 2007
[13] L. D. Baker and A. K. McCallum, Distributional clustering of words for text classification. In Proceedings of the 21st Annual International ACM SIGIR Conference on Research and Development in Information Retrieval, 1998
[14] R. Bekkerman, R. El-Yaniv, N. Tishby and Y. Winter, Distributional word clusters vs. words for text categorization, The Journal of Machine Learning Research, 2003
[15] Dekang Lin, Automatic retrieval and clustering of similar words. In Proceedings of the 17th International Conference on Computational Linguistics, 1998
[16] G. Grefenstette, Explorations in automatic thesaurus discovery, 1994, Kluwer Academic Publishers
[17] L. Lee, Measures of distributional similarity. In Proceedings of the 37th Annual Meeting of the Association for Computational Linguistics, 1999
[18] Christiane Fellbaum ed., WordNet: An electronic lexical database, 1998, The MIT Press
[19] A. Novischi, M. Srikanth and A. Bennett, Lcc-wsd: System description for English coarse grained all words task at Semeval 2007. In Proceedings of the Fourth International Workshop on Semantic Evaluations, 2007

What is claimed is:

1. A method for determining a probabilistic, context dependent word distribution for each word in a previously unseen text, the method comprising:
in a training phase, learning for each word of a large corpus of natural language texts a probabilistic context model that describes the context these words typically occur in and learning a hidden-to-observed distribution that that describes words with similar meaning and usage;
storing the context model and the hidden-to-observed distribution on a storage device; and
in an inference phase, retrieving the context model and the hidden-to-observed distribution from the storage device and for each word in the previously unseen text determining the probabilistic, context dependent word distribution utilizing the context model and the hidden-to-observed distribution obtained in the training phase.

2. The method according to claim 1 wherein, in the training phase, the probabilistic context model and the context dependent word distribution are iteratively refined.

3. The method according to claim 1 wherein the training phase comprises:
tokenizing the corpus of natural language texts into individual words;
representing the corpus of natural language text with a Bayesian model with a hidden or latent variable for every word in the corpus, the Bayesian model representing the context dependent set of similar words, and with dependencies between the hidden variable and the hidden variables in its context, the dependencies representing the context model, and with dependencies between the hidden variable and the observed word at that position, the dependencies representing the hidden-to-observed distribution; and
utilizing approximate inference methods to determine a probabilistic distribution of words for the hidden variables, to learn the context model and to learn the hidden-to-observed distribution.

4. The method according to claim 2 wherein the training phase comprises:
tokenizing the corpus of natural language texts into individual words;
representing the corpus of natural language text with a Bayesian model with a hidden or latent variable for every word in the corpus, the Bayesian model representing the context dependent set of similar words, and with dependencies between the hidden variable and the hidden variables in its context, the dependencies representing the context model, and with dependencies between the hidden variable and the observed word at that position, the dependencies representing the hidden-to-observed distribution; and
utilizing approximate inference methods to determine a probabilistic distribution of words for the hidden variables, to learn the context model and to learn the hidden-to-observed distribution.

5. The method according to claim 1 wherein the inference phase comprises:
tokenizing the text into individual words;
representing the text with a Bayesian model with a hidden or hidden variable for every word in the corpus, the Bayesian model representing the context dependent set of similar words, and with dependencies between the hidden variable and the hidden variables in its context and between the hidden variable and the observed word at that position; and
utilizing the context model and the hidden-to-observed distribution learned in the training phase together with approximate inference methods to determine a probabilistic distribution of words for the hidden variables in a previously unseen text.

6. The method according to claim 2 wherein the inference phase comprises:
tokenizing the text into individual words;
representing the text with a Bayesian model with a hidden or hidden variable for every word in the corpus, the Bayesian model representing the context dependent set of similar words, and with dependencies between the hidden variable and the hidden variables in its context and between the hidden variable and the observed word at that position; and
utilizing the context model and the hidden-to-observed distribution learned in the training phase together with approximate inference methods to determine a probabilistic distribution of words for the hidden variables in a previously unseen text.

7. The method according to claim 3 wherein the inference phase comprises:
tokenizing the text into individual words;
representing the text with a Bayesian model with a hidden or hidden variable for every word in the corpus, the Bayesian model representing the context dependent set of similar words, and with dependencies between the hidden variable and the hidden variables in its context and between the hidden variable and the observed word at that position; and
utilizing the context model and the hidden-to-observed distribution learned in the training phase together with approximate inference methods to determine a probabilistic distribution of words for the hidden variables in a previously unseen text.

8. The method according to claim 4 wherein the inference phase comprises:
tokenizing the text into individual words;
representing the text with a Bayesian model with a hidden or hidden variable for every word in the corpus, the Bayesian model representing the context dependent set of similar words, and with dependencies between the hidden variable and the hidden variables in its context and between the hidden variable and the observed word at that position; and
utilizing the context model and the hidden-to-observed distribution learned in the training phase together with approximate inference methods to determine a probabilistic distribution of words for the hidden variables in a previously unseen text.

9. A method for automatic analysis of natural language, the method comprising:
utilizing a probabilistic, context dependent word distribution determined by the method according to claim 1 for each word in a previously unseen text.

10. The method according to claim 9, wherein the automatic analysis is semantic role labeling.

11. A method for automatic analysis of natural language, the method comprising:
utilizing a probabilistic, context dependent word distribution determined by the method according to claim 2 for each word in a previously unseen text.

12. The method according to claim 11, wherein the automatic analysis is semantic role labeling.

13. A method for automatic analysis of natural language, the method comprising:
utilizing a probabilistic, context dependent word distribution determined by the method according to claim 3 for each word in a previously unseen text.

14. The method according to claim 13, wherein the automatic analysis is semantic role labeling.

15. A method for automatic analysis of natural language, the method comprising:
utilizing a probabilistic, context dependent word distribution determined by the method according to claim 4 for each word in a previously unseen text.

16. The method according to claim 15, wherein the automatic analysis is semantic role labeling.

17. A method for automatic analysis of natural language, the method comprising:
utilizing a probabilistic, context dependent word distribution determined by the method according to claim 5 for each word in a previously unseen text.

18. The method according to claim 17, wherein the automatic analysis is semantic role labeling.

19. A method for automatic analysis of natural language, the method comprising:
utilizing a probabilistic, context dependent word distribution determined by the method according to claim 6 for each word in a previously unseen text.

20. The method according to claim 19, wherein the automatic analysis is semantic role labeling.
